(19) United States
(12) Patent Application Publication
(10) Pub. No.: US 2020/0226358 A1
(43) Pub. Date: Jul. 16, 2020

(54) METHOD FOR RECOGNIZING SEQUENCES OF MOVEMENTS AND PASSING RECOGNITION SYSTEM

(71) Applicant: Kaba Gallenschütz GmbH, Buhl (DE)

(72) Inventor: Arno VOLLMER, Buhl (DE)

(21) Appl. No.: 16/741,572

(22) Filed: Jan. 13, 2020

(30) Foreign Application Priority Data
Jan. 14, 2019 (EP) 19151695.4

(51) Int. Cl. G06K 9/00

(52) U.S. Cl. CPC G06K 9/00342; G06K 9/00771

(57) ABSTRACT

A method for contactlessly recognizing at least one sequence of movements, including at least one sensor unit for detecting respectively at least one condition of movement within a detection area of the sensor unit, a transmitting unit for transferring the at least one detected condition of movement, and a computing unit with a receiving unit for receiving the at least one detected condition of movement. The method also includes an evaluating unit for evaluating the at least one detected condition of movement as well as with a supply unit for supplying the at least one evaluated condition of movement and/or the at least one recognized sequence of movements. Furthermore, a passing recognition system for performing the method is related.

### CROSS REFERENCE TO RELATED APPLICATIONS

This application is related to and claims the benefit of European Patent Application No. 19151695.4, filed on Jan. 14, 2019, the contents of which are hereby incorporated by reference in their entirety.

### TECHNICAL FIELD

The present disclosure relates to a method for contactlessly recognizing at least one sequence of movements and to a passing recognition system.

### BACKGROUND

The state-of-the-art knows methods, which recognize sequences of movements, in particular individuals passing through detection areas, respectively entering into said areas and/or leaving said areas, with detection units. At entrances and exits in buildings or areas, in particular access-restricted areas, for example turnstiles, personnel locks or barriers are employed for the targeted entry or exit control. The known solutions for controlling the entry and exit are disadvantageous in that most of the time they open in a time-based manner or simply perform a motor-driven sequence for the entry or exit. Said solutions are prone to abusive utilization of the non-existing or inexact control of individuals entering or exiting, in particular of the number of individuals, such that for example two individuals, vehicles or other mobile objects are able to pass during one opening phase.

### SUMMARY

The present disclosure addresses the above-described issues at least partially. In particular, the present disclosure provides a method for contactlessly recognizing at least one sequence of movements, which with high precision and also at a little distance between two individuals, vehicles or other mobile objects following each other allows for recognizing the sequences of movements. Furthermore, the disclosure discloses a passing recognition system.

The above-mentioned advantage is achieved by means of the patent claims. In particular, the above-mentioned advantage is achieved by means of the method according to claim 1, as well as the passing recognition system according to claim 14. Further advantages of the disclosure will result from the dependent claims, the description and the drawings. In this case, features and details, described in conjunction with the inventive method, are obviously also valid in conjunction with the inventive passing recognition system and respectively vice versa, such that mutual reference is made, respectively can be made with respect to the disclosure of the individual aspects of the disclosure.

According to a first aspect of the present disclosure, a method is provided for contactlessly recognizing at least one sequence of movements with a passing recognition system. The passing recognition system includes at least one sensor unit, in particular having at least two, particularly advantageously four sensors, which in particular are disposed in a row with regard to each other, for detecting respectively at least one condition of movement within a detection area of the sensor unit, a transmitting unit for transferring the at least one detected condition of movement and a computing unit with a receiving unit for receiving the at least one detected condition of movement. Furthermore, the computing unit comprises an evaluation unit for evaluating the at least one detected condition of movement as well as a supply unit for supplying the at least one evaluated condition of movement and/or the at least one recognized sequence of movements. The following steps characterize the method:
at least one sensor unit detecting at least one first condition of movement and at least one second condition of movement within the detection area, wherein a first condition of movement and a second condition of movement are detected at different points in time,
the transmitting unit transferring the at least two detected conditions of movement to the receiving unit of the computing unit,
the receiving unit of the computing unit receiving the at least two detected conditions of movement,
the evaluating unit of the computing unit recognizing at least one sequence of movements on the basis of the at least two received conditions of movement,
a supply unit of the computing unit supplying the at least two evaluated conditions of movement and/or the at least one recognized sequence of movements.

Advantageously, with high precision and also at little distance between two individuals, vehicles or other mobile objects following each other, such a configured inventive method allows for recognizing the at least one sequence of movements. In this case, a sequence of movements means walking through and/or passing the detection area of the sensor unit. Within the scope of the disclosure, a condition of movement is understood as the at least one sensor unit realizing a snapshot of the detected area. Thus visually expressed, a condition of movement indicates which sensor unit at which position recognizes a movement, for example in the shape of a newly recognized object and/or of an individual in the detection area. The inventive method is particularly advantageous in detecting at least two conditions of movement, which can be put in relation to each other and thus allow for drawing further conclusions when the evaluating unit of the method recognizes the sequences of movements. In particular, a sequence of movements is recognized based on the temporal comparison of conditions of movement. The sensor units can comprise at least one sensor or a plurality of sensors. Within the sensor unit, sensors can be disposed next to each other, one above the other and/or diagonally with regard to each other. Likewise, the proper sensor units can include a vertical, horizontal or diagonal arrangement in the installed condition. Sensors are distinguished as active sensors and passive sensors. An active sensor currently detects an individual or an object. A passive sensor does not currently detect an individual or an object in the detection area thereof. A sensor unit can include at least one source and at least one receiver and/or detect by means of reflexion. In particular, the at least one sensor unit is configured as a light barrier, one-way light barrier, reflexion light barrier and/or light array. A distinction between an individual and an object carried by an individual, such as a bag, can be realized in the inventive method by evaluating the detected conditions of movement. In particular, the inventive method can be performed to be computer-implemented.

According to a further development of the present disclosure, it is possible the computing unit recognizing the at least one sequence of movements comprises recognizing a direction of the at least one sequence of movements. As an alternative or in addition, a sequence of movements is an entry and an exit into the detection area of the sensor unit from the same direction and into the same direction or in different directions, consequently a sequence of movements with a turn or a mentioned passing. Graphically expressed, when unilaterally walking through the detection area of the at least one sensor, the detection area includes one entry side and one exit side. Obviously, the sides of the function thereof can be exchanged and consequently the detection area can be walked through from the other side or be used from both sides respectively as an entry side and as an exit side. In particular, a direction is recognized from the temporal course of the detection, for example of an individual. In this case, the at least one sensor unit detects a direction of the at least one sequence of movements of at least two conditions of movement and/or at least two sensor units detect respectively one condition of movement. In this case, recognizing the direction of the sequence of movements is realized from the temporal course in combination with the local arrangement of the active and passive sensors of the at least one sensor unit. Graphically expressed, a direction of a sequence of movements is recognized from the right to the left hand side, if, to begin with, a sensor disposed on the right hand side is active and a sensor disposed on the left hand side gets passive again to end with. The method can make use of only one type of construction and/or one detection method of sensor units for the inventive method steps for detecting or can comprise several differing sensor units. In particular, differing sensor units can be employed for detecting the at least one condition of movement and detecting the direction of the at least one sequence of movements.

In an advantageous embodiment variant of the inventive method, it is possible for the computing unit that recognizing the at least one sequence of movements comprises recognizing a number of at least one recognized sequence of movements, in particular a number of individuals associated to the at least one sequence of movements. Thus advantageously, the inventive method can recognize the number of individuals and/or objects passing the detection area, for example. In combination with an access control, the inventive method allows for recognizing a following of an unauthorized individual. In this case, the at least one sensor unit detects anew a number of the at least one sequence of movements, in particular based on at least two conditions of movement and/or at least two sensor units detect based on respectively one condition of movement.

Likewise in an advantageous embodiment variant of the inventive method, it is possible for recognizing the number of the at least one sequence of movements on the basis of a separation criterion. In particular, when recognizing at least one sequence of movements on the basis of the evaluating unit having received at least two conditions of movement, a separation criterion represents a criterion which distinguishes between two sequences of movements, for example of two individuals, one individual and an object or two objects. The detected sequences of movements will result from a graphical illustration of the temporal course of the detected conditions of movement. Within the scope of the disclosure, an illustrative separation criterion can include a row of passive sensors between active sensors. They represent a detected distance between two individuals, for example, which are being recognized in the inventive method. In the reverse conclusion, likewise a separation criterion can comprise exclusions or special criteria, which exactly should not be taken as separation criteria. In the inventive method, for example, with a particularly tall individual having a high stride, obviously the legs are not to be detected as two individuals.

Likewise in an advantageous embodiment variant of the inventive method, it is possible for the separation criterion to include at least one detected passive condition of movement temporally before or after a detected active condition of movement. Analogously to the previous section, the evaluating unit recognizes a gap between two individuals, for example based on a passive sensor next to an active sensor and/or between two active sensors. In combination with the further recognition analysis of the disclosure, the two objects, respectively individuals, forming the distance can be classified as objects and/or as individuals. Thus, an inventive method allows for a reliable recognition of a number of individuals and objects when walking through a passing recognition system.

Likewise in an advantageous embodiment variant of the inventive method, it is possible for the separation criterion to include at least one detected passive condition of movement locally above or below a detected active condition of movement. In addition to a temporal course of conditions of movement, according to said further development of the inventive method, likewise the local, in particular the height of the active and passive sensors of the at least one sensor unit can be considered. For example, in such a further developed method, a hole in the area of passive sensors can be recognized, which is surrounded by active sensors. Thus, the method can guarantee a reliable recognition, even with individuals following each other very closely, wherein no complete gap is created between them.

In a likewise advantageous embodiment variant of the inventive method, it is possible for the method, in particular a supply unit of the computing unit supplying the at least two evaluated conditions of movement and/or the at least one sequence of movements, to comprise a visual, acoustic and/or motor-driven output by means of an output unit. Within the scope of the disclosure, an output is a visual and/or an acoustic alarm. As an alternative or in addition, the output of the output unit can include opening or closing door leaves. It is likewise possible that the output is a visual output, for example on a display, which can output statistics on the detected conditions of movement. Thus, the inventive method allows for an advantageous output, for example for alerting security personnel when two individuals following each other directly are recognized during a passage through the detection area of the at least one sensor unit.

In a further advantageous embodiment variant of the inventive method, it is possible that the at least one sensor unit realizes recognizing the at least two conditions of movement within a respective two-dimensional or respectively essentially two-dimensional detection area. Within the scope of the disclosure, an essentially two-dimensional detection area is a detection area with a multiple extension, at least three times greater extension in two directions of propagation when compared to the third direction of propagation. Graphically, an essentially two-dimensional detection area can represent a detection plane, which, within the scope of technical possibilities of the disclosure, has a small thickness. A sensor unit is in particular configured as a light barrier and consequently includes a detection area starting from the light barrier and having a beam shape and/or cone shape, respectively with a plurality of sensors disposed next to each other, a wedge shape, plane or flat shape. The sensor unit can be disposed horizontally or vertically. A method having such configured sensor unit allows for an advantageous and better separation when detecting following individuals and/or objects.

Moreover, in a method according to the present disclosure, it is possible for the transmission, the reception and/or the evaluation of the at least two detected conditions of movement to be performed only when detecting a change in at least one first condition of movement compared to at least one second condition of movement. Such a configured method is particularly energy-saving and resource-saving and, for example, performs the following communications and/or evaluation steps of the method only when having recognized the necessity based on changed input data in form of a detected change in at least one first condition of movement compared to at least one second condition of movement, which was temporally detected earlier or later.

Furthermore, it can be of advantage if the inventive method comprises:
a conversion unit (38) of the computing unit (30) converting the data of the at least two detected conditions of movement (2).

According to the disclosure, a conversion of data can be a procedural standardized illustration of data or an adaptation to standards in line with industry customs. A conversion of data makes further utilization and processing of detected data by further devices easy and, for example, thus allows for advantageously reducing the effort for integrating further evaluation methods on the basis of the detected data of the inventive method. In particular, the conversion can convert the detected conditions of movement respectively into a variable of the data type integer having 64 bits or more. The number of bits is chosen by way of example in order to be able to realize further sensor configurations having 64 sensors or more.

Moreover, in a method of the present disclosure, it is possible that the conversion of data comprises an addition of active sensors of the at least one sensor unit. An addition of active sensors of the at least one sensor unit allows for reducing the data to be transferred. For example, instead of an active/passive state for each sensor of a sensor unit, a single status with the number of active, respectively passive sensors of the sensor unit can be transferred and processed.

Moreover, in a method according to the present disclosure, it is advantageous if the conversion of data deletes at least one detected condition of movement on the basis of recognizing the at least one sequence of movements. The inventive method can classify detected conditions of movement as non-relevant for the detection of sequences of movements and consequently remove them from the basis for recognizing sequences of movements. Likewise, deleting such sequences of movements can be a simple non-processing or separately marking of the conditions of movement in question. For example, a single active sensor, which is exclusively or mainly surrounded by passive sensors, can be classified as a non-relevant condition of movement. Likewise thin lines of active sensors can be classified as non-relevant, graphically expressed. Basically, according to a further development of the disclosure, conditions of movement, which an individual cannot trigger, can be classified as non-relevant for the recognition of sequences of movements of individuals. Usual geometrical dimensions of an individual can be considered for example as the basis for such a classification.

Furthermore, it can be of advantage if the inventive method comprises:
the computing unit determining a frontal profile line of an individual and/or of an object within the detection area on the basis of the at least one received condition of movement.

An advantageous configuration of the inventive method provides for recognizing a profile line, in particular the frontal entry line of a profile, of an individual, respectively of an object. When passing the detection area of the at least one sensor unit, an individual has a specific profile line, respectively frontal edge of the profile, which is different from the profile line, respectively from the frontal edge of the profile of an object. In particular, entering the detection area of the at least one sensor unit at first with a leg and/or a foot is characterizing for the frontal edge of the profile of a person. Thus advantageously, in the inventive method, it is ensured that a bag of an individual will not be recognized as a following individual.

According to a second aspect of the present disclosure, is provided a passing recognition system for performing the method according to the first aspect. The passing recognition system comprises at least one first sensor unit for detecting respectively at least one condition of movement within a detection area of the at least one sensor unit, a transmitting unit for transferring the at least one detected condition of movement, a computing unit with a receiving unit for receiving the at least one detected condition of movement, with an evaluating unit for evaluating the at least one detected condition of movement as well as with a supply unit for supplying the at least one evaluated condition of movement and/or the at least one recognized sequence of movements. The passing recognition system is configured for recognizing at least one sequence of movements, in particular of sequences of movements of individuals, particularly advantageously it comes in the form of a personnel lock. The sensor unit of the passing recognition system can include at least one source and at least one receiver and/or detect by means of reflexion. In particular, the at least one sensor unit is configured as light barriers, one-way light barrier, reflexion light barrier and/or light array. Advantageously, an arrangement of the at least one sensor unit provides for recognizing individuals at the level of legs/hips. Preferably, at least one sensor unit realizes detecting the respectively at least one condition of movement within an essentially respectively two-dimensional detection area. Thus, at the least possible cost and expense, the passing recognition system can allow for recognizing sequences of movements at a high precision also at a small distance between two individuals, vehicles and/or other mobile objects following each other. Thereby, a passing recognition system also has the same advantages as the ones described above in detail for an inventive method.

Preferably moreover, an inventive passing recognition system can be further developed in that at least two sensor units for detecting respectively at least one condition of movement are disposed within a respective detection area of the at least two sensor units in the passing recognition system. The passing recognition system can make use of only one type of construction and/or one detection method of sensor units for the inventive method steps for detecting or can comprise several differing sensor units. In particular, differing sensor units can be employed for detecting the at least one condition of movement and detecting the direction of the at least one sequence of movements. The sensor units can comprise at least one sensor or a plurality of sensors. Within the sensor unit, sensors can be disposed next to each other, one above the other and/or diagonally with regard to each other. Likewise, the proper sensor units can include a vertical, horizontal or diagonal arrangement in the installed condition.

Particularly preferred, an inventive passing recognition system can be formed in that an output unit of the passing recognition system is configured for the visual, acoustic and/or motor-driven output on the basis of the supply unit supplying the at least one evaluated condition of movement and/or of the at least one sequence of movements. Within the scope of the method, an output is a visual alarm and/or an acoustic alarm. As an alternative or in addition, the output of the output unit can include opening or closing door leaves. It is likewise possible that the output is a visual output, for example on a display, which can output statistics on the detected conditions of movement.

Likewise preferably, an inventive passing recognition system can be formed in that a conversion unit of the computing unit be configured for converting the data of the at least one detected condition of movement. According to the disclosure, a conversion of the data can be a system-specific standardized illustration of data or an adaptation to standards in line with industry customs. A conversion of the data makes further utilization and processing of the detected data by further devices easy and, for example, thus allows for advantageously reducing the effort for integrating for example further evaluation methods on the basis of the detected data of the inventive passing recognition system.

### BRIEF DESCRIPTION OF THE DRAWINGS

An inventive method as well as an inventive passing recognition system as well as the further advantages thereof will be explained in more detail based on the drawings: In the FIGS. 1 to 5, the same reference numerals respectively identify elements having the same function and manner of operation.

It is diagrammatically shown in:

FIG. 1 a flowchart of an embodiment of an inventive method having a sensor unit, a transmitting unit, a computing unit with a receiving unit, an evaluating unit as well as a supply unit and a conversion unit and an output unit,

FIG. 2 a lateral view of an embodiment of an inventive passing recognition system having two sensor units,

FIG. 3 an illustration form of an inventive sequence of movements on the basis of a plurality of detected conditions of movement,

FIG. 4 a further illustration form of an inventive sequence of movements on the basis of a plurality of detected conditions of movement with a profile line, and

FIG. 5 a further illustration form of an inventive sequence of movements on the basis of a plurality of detected conditions of movement with a profile line.

### DETAILED DESCRIPTION OF THE DRAWINGS

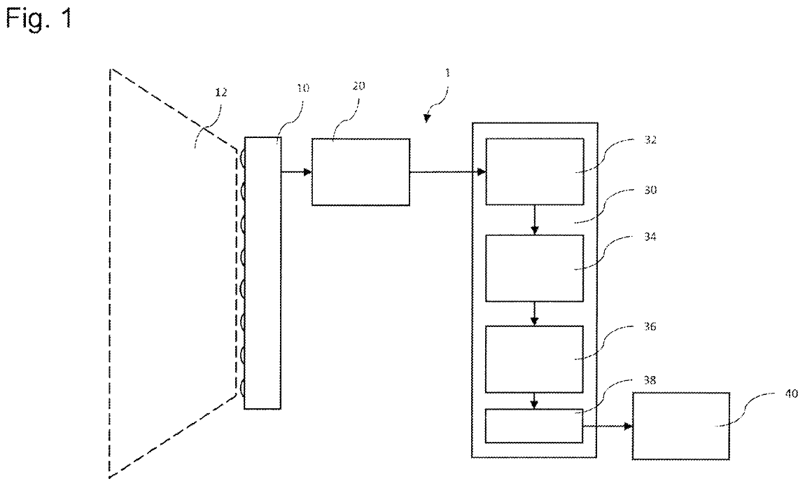

FIG. 1 shows a flowchart of one embodiment of an inventive method with a sensor unit 10 for detecting respectively at least one condition of movement 2 within a detection area 12 of the sensor unit 10. Furthermore, the method comprises a sensor unit 20 for transferring the at least one detected condition of movement 2, a computing unit 30 with a receiving unit 32 for receiving the at least one detected condition of movement 2, with an evaluating unit 34 for evaluating the at least one detected condition of movement 2 as well as with a supply unit 36 for supplying the at least one evaluated condition of movement 2 and/or the at least one recognized sequence of movements 4. Advantageously, with high precision and also at little distance between two individuals, vehicles or other mobile objects following each other such a configured inventive method allows for recognizing the at least one sequence of movement 4. The sensor unit 10 comprises a plurality of sensors, in order to allow for a vertically larger detection area 12. For this purpose, the sensor unit 10 is disposed vertically in an exemplary embodiment. In one embodiment, the sensor unit 10 extends vertically at a perpendicular angle to a surface upon which the individual is traversing. The vertical, e.g., perpendicular, configuration advantageously provides sensor readings extending to the mid-section of the individual thereby providing enhanced accuracy of sensor readings. For example, the mid-section of an individual is generally the largest body diameter and therefore provides a very good signal for a gap between successively moving individuals. The sensor unit 10 may also be disposed diagonally to the traversal surface, for example, between a perpendicular configuration and a configuration coplanar or parallel with the surface. In one embodiment, the sensor unit 10 may be positioned between 10 degrees and 80 degrees from vertical. In another embodiment, the sensor unit 10 may be positioned between 20 degrees and 70 degrees from vertical. In yet another embodiment, the sensor unit 10 may be positioned between 30 degrees and 60 degrees from vertical. In a still further embodiment, the sensor unit 10 may be positioned between 40 degrees and 50 degrees from vertical. In an exemplary embodiment, the sensor unit 10 may be positioned at a 45-degree angle from vertical.

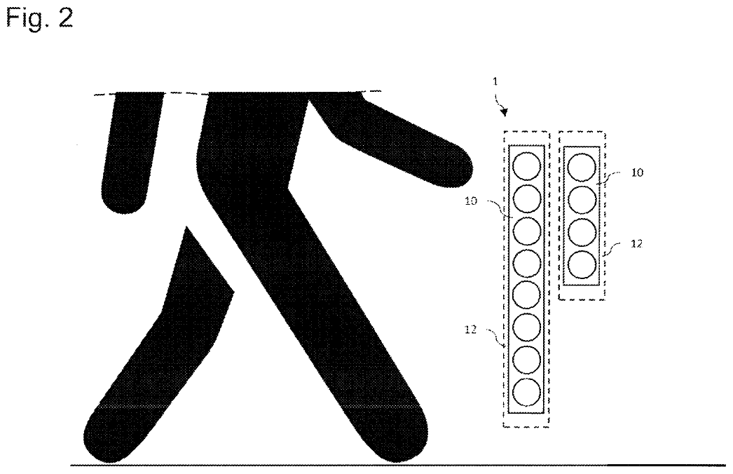

FIG. 2 shows a lateral view of an embodiment of an inventive passing recognition system 1 with two sensor units 10. In this case in particular, the left sensor unit 10 is adapted for detecting the conditions of movement 2 for recognizing sequences of movements 4 (not shown). The right sensor unit 10 serves for an exemplary complementary detection of conditions of movement 2, in order to allow for the evaluating unit 34 of the computing unit 30 evaluating the direction of the recognized sequences of movements 4 (not shown).

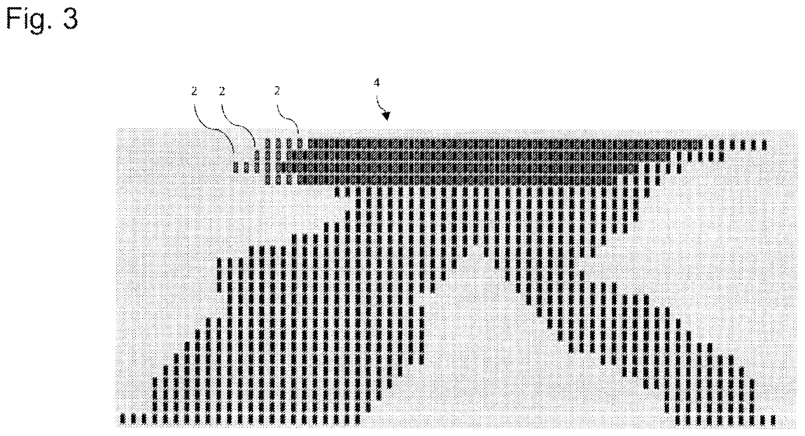

FIG. 3 shows an illustration form of an inventive sequence of movements 4 on the basis of a plurality of detected conditions of movement 2, for example of a passing recognition system 1 according to FIG. 2. Filled squares represent an object a sensor of the sensor unit 10 recognized in the detection area 12. For example, when employing light barriers, the non-filled squares represent a single light array, in which an individual and/or an object have/has not interrupted the light beam. Thus, the sensor corresponding thereto is passive. Each column represents a detected condition of movement 2.

The plurality of columns results from a temporal course of the detected conditions of movement 2. Each line represents the detected conditions of movement 2 of respectively at least one sensor of the sensor units 10. The upper four lines show respectively the detected conditions of movement 2 of the sensors of two sensor units 10. The filled rectangles correspond to the sensors of the left sensor unit 10; the non-filled rectangles correspond to the sensors of the right sensor unit 10. The oldest detected conditions of movement 2 are illustrated on the right-hand side in FIG. 3. The newest detected conditions of movement 2 are illustrated on the left-hand side in FIG. 3. Thus, by way of example, FIG. 3 shows an entry of an individual from the left-hand side into the detection area 12. This is recognizable by the left sensor unit 10 at first detecting a condition of movement 2 (see FIG. 3 on the right, filled rectangles). The individual leaves the detection area 12 to the right (see FIG. 3, upper four lines, left, non-filled rectangles).

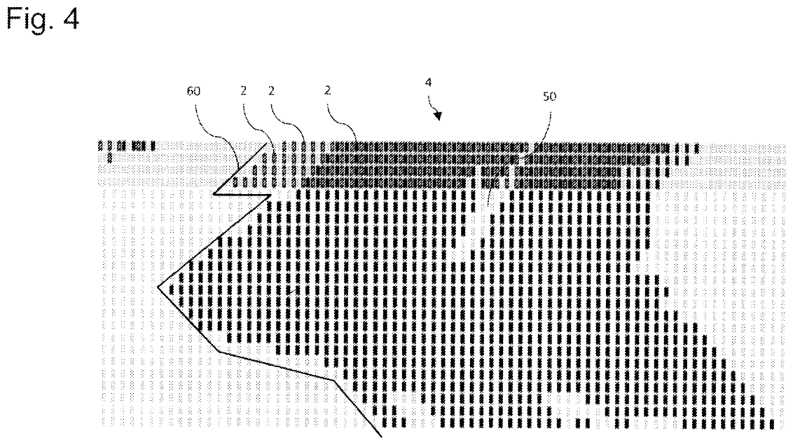

FIG. 4 shows an illustration form of an inventive sequence of movements 4 on the basis of a plurality of detected conditions of movement 2, for example of a passing recognition system 1 according to FIG. 2. Thus, by way of example, FIG. 4 shows two individuals passing, respectively in the scenario of the access control, a non-authorized second individual following from the left into and through the detection area 12. This is recognizable by at first the left sensor unit 10 (see FIG. 3 on the right, filled rectangles) detecting a condition of movement 2. The individual leaves the detection area 12 to the right (see FIG. 3, upper four lines, left, non-filled rectangles). An inventive method and an inventive passing recognition system 1 can recognize the two individuals following each other very closely. For this purpose, the detected conditions of movement 2 of the at least one sensor unit 10 are evaluated together. Advantageously, the at least one sensor unit 10, respectively the sensors are disposed at a level, at which is located the hip of an individual. According to an embodiment of the inventive method, recognizing the number of the at least one sequence of movements 4 can be realized on the basis of a separation criterion 50. In particular, when recognizing at least one sequence of movements 4 on the basis of the evaluating unit 34 having received at least two conditions of movement 2, a separation criterion represents a criterion based on which two sequences of movements 2 of two individuals can be distinguished. In FIG. 4, the separation criterion 50 is a hole, namely an area of passive sensors, which is surrounded by active sensors. Thus, the method can guarantee a reliable recognition, even with individuals following each other very closely, wherein no complete gap is created between them. On the basis of said separation criterion 50, it is compelling to assume that two individuals follow each other very closely or that a piece of luggage is being carried in front or behind them. This distinction can be differentiated in a further analysis of the inventive method and consequently it can be reliably recognized whether or not one or more individual/s has/have passed through the passing recognition system 1.

FIG. 4 likewise shows recognizing a profile line 60, in particular the frontal entry line of a profile, of an individual, or of an object. When passing through the detection area 12 of the at least one sensor unit 10, an individual has a specific profile line 60, for example, a frontal edge of the profile, which is different from the profile line 60 of an object. In particular, entering the detection area 12 of the at least one sensor unit 10 at first with a leg and/or a foot is characterizing for the frontal edge of the profile of a person.

Thus advantageously, in the inventive method, it is ensured that a bag of an individual will not be recognized as a following individual.

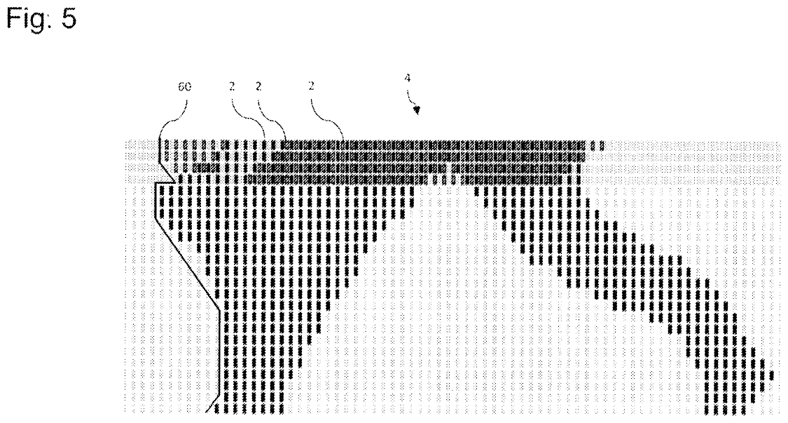

FIG. 5 shows an example for a special case, which will be excluded by a separation criterion 50. In the inventive method, for example, with a particularly tall individual having a high stride, obviously the legs are not to be detected as two individuals. For this purpose, the graphically generated triangle of passive sensors can be excluded from the separation criterion 50.

1. A method for contactlessly recognizing at least one sequence of movements with a passing recognition system, including at least one first sensor unit for detecting respectively at least one condition of movement within a detection area of the sensor unit, a transmitting unit for transferring the at least one detected condition of movement, a computing unit with a receiving unit for receiving the at least one detected condition of movement and with an evaluating unit for evaluating the at least one detected condition of movement as well as with a supply unit for supplying the at least one evaluated condition of movement and/or the at least one recognized sequence of movements, the method including the following steps:
detecting, with the at least one sensor unit, at least one first condition of movement and at least one second condition of movement within the detection area, wherein the first condition of movement and the second condition of movement are detected at different points in time,
transferring, with the transmitting unit, the at least two detected conditions of movement to the receiving unit,
receiving, by the receiving unit, the at least two detected conditions of movement,
recognizing, with the evaluating unit, at least one sequence of movements on the basis of the at least two received conditions of movement, and
supplying, with a supply unit of the computing unit, the at least two evaluated conditions of movement and/or the at least two recognized conditions of movement.

2. The method according to claim 1, wherein
the computing unit recognizing the at least one sequence of movements comprises recognizing a direction of the at least one sequence of movements.

3. The method according to claim 1, wherein
the computing unit recognizing the at least one sequence of movements comprises recognizing a number of the at least one recognized sequence of movements.

4. The method according to claim 3, wherein
the recognizing the number of the at least one sequence of movements is realized on the basis of a separation criterion.

5. The method according to claim 4, wherein
the separation criterion includes at least one detected passive condition of movement temporally before or after a detected active condition of movement.

6. The method according to claim 4, wherein
the separation criterion includes at least one detected passive condition of movement locally above or below a detected active condition of movement.

7. The method according to claim 1, wherein
the evaluating unit of the computing unit supplying the at least two evaluated conditions of movement and/or the at least one sequence of movements comprises an output unit outputting a visual output, an acoustic output, and/or a motor-driven output.

8. The method according to claim 1, wherein
the at least one sensor unit realizes detecting the at least two conditions of movement within a respectively essentially two-dimensional detection area.

9. The method according to claim 1, wherein
the transmission, the reception, and/or the evaluation of the at least two detected conditions of movement are performed only when detecting a change in at least one first condition of movement compared to at least one second condition of movement.

10. The method according to claim 1, wherein
the method further comprises:
a conversion unit of the computing unit converting the data of the at least two detected conditions of movement.

11. The method according to claim 10, wherein the
step of converting the data further includes an addition of active sensors of the at least one sensor unit.

12. The method according to claim 10, wherein the
step of converting the data deletes at least one detected condition of movement for the basis of recognizing the at least one sequence of movements.

13. The method according to claim 1, wherein
the method further comprises:
the computing unit determining a frontal profile line of an individual and/or of an object within the detection area on the basis of the at least one received condition of movement.

14. A passing recognition system for contactlessly recognizing at least one sequence of movements of an object on a surface, comprising at least one first sensor unit for detecting at least one condition of movement within a detection area of the at least one sensor unit, a transmitting unit for transferring the at least one detected condition of movement, and a computing unit comprising a receiving unit for receiving the at least one detected condition of movement, an evaluating unit for evaluating the at least one detected condition of movement, and a supply unit for supplying at least one of the at least one evaluated condition of movement and the at least one recognized sequence of movements.

15. The passing recognition system according to claim 14, further comprising:
at least two sensor units for detecting at least one condition of movement within the detection area of the at least two sensor units.

16. The passing recognition system according to claim 14, further comprising:
an output unit configured to provide at least one of visual, acoustic and motor-driven output on a basis of the supply unit supplying at least one of the at least one evaluated condition of movement and the at least one recognized sequence of movements.

17. The passing recognition system according to claim 14, further comprising:
a conversion unit of the computing unit is configured for converting the data of the at least one detected condition of movement.

18. The passing recognition system according to claim 14, wherein the sensor unit is configured to extend perpendicularly to the surface.

19. The passing recognition system according to claim 14, wherein the sensor unit is configured to extend diagonally to the surface.

20. The passing recognition system according to claim 19, wherein the sensor unit is configured at a 45-degree angle with respect to a line extending perpendicular to the surface.
